(19) United States
(12) Patent Application Publication
(10) Pub. No.: US 2009/0064205 A1
(43) Pub. Date: Mar. 5, 2009

(54) SYSTEM AND METHOD FOR HARVESTING SERVICE METADATA FROM A METADATA REPOSITORY INTO AN ARCHITECTURE DIAGRAM

(75) Inventors: Sharon Y. Fay, Bay Village, OH (US); Randy B. Beiter, North Olmsted, OH (US); David S. Keyes, Clinton, OH (US); Jeremy R. Lemmon, Evans, GA (US); Adam J. Wallace, Mentor, OH (US)

Correspondence Address: Fliesler Meyer LLP, 650 California Street, 14th Floor, San Francisco, CA, 94108, US

(73) Assignee: ORACLE INTERNATIONAL CORPORATION, Redwood Shores, CA (US)

(21) Appl. No.: 12/193,616

(22) Filed: Aug. 18, 2008

Related U.S. Application Data
(60) Provisional application No. 60/956,272, filed on Aug. 16, 2007.

(51) Int. Cl. G06F 9/54; G06F 17/30; G06F 12/00

(52) U.S. Cl. 719/329; 719/328; 707/3; 707/203; 707/E17.044; 707/E17.014

(57) ABSTRACT

Embodiments of the invention are generally related to architecture diagrams and metadata repositories, particularly with regards to systems and methods for harvesting service metadata from a metadata repository into an architecture diagram. One embodiment includes a plug-in to an architecture design tool communicating to the service metadata repository through an application programming interface. One embodiment includes incorporating service metadata entities from a service metadata repository into architecture diagram entities in an architecture diagram.

### CLAIM OF PRIORITY

The present application claims the benefit of priority under 35 U.S.C. § 119(e) to U.S. Provisional Patent Application No. 60/956,272 entitled “SYSTEM AND METHOD FOR HARVESTING ARCHITECTURE DIAGRAMS INTO A METADATA REPOSITORY,” filed on Aug. 16, 2007, which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATION

The following U.S. patent application is cross-referenced and incorporated herein by reference:

U.S. patent application Ser. No. ______ entitled “SYSTEM AND METHOD FOR HARVESTING SERVICE METADATA FROM AN ARCHITECTURE DIAGRAM INTO A METADATA REPOSITORY,” filed Aug. 18, 2008 (Attorney Docket No. ORACL-02234US2-SRM/TKP).

### FIELD OF THE INVENTION

This invention is related to architecture design in the information technology field, particularly with regard to harvesting information contained in architecture diagrams for reuse with a metadata repository.

### BACKGROUND

Enterprise Architects use a wide range of design tools to diagram and design information technology systems. According to a 2005 report by the Institute for Enterprise Architecture Developments, thirty-three percent of the organizations surveyed are using Microsoft Visio®. Twenty-nine percent of the organizations are using Microsoft Office® tools such as MS Word, MS Excel®, and MS Powerpoint®. Another fifteen percent of the organizations are using Telelogic System Architect®. The remaining surveyed organizations used additional tools.

Service-Oriented Architecture (SOA) is based on the deconstruction of yesterday's monolithic applications and information technology infrastructure into a matrix of discrete, standards-based, network-accessible services. The process of transformation requires the organization, identification, and repurposing of applications and business processes of the existing information technology infrastructure. The transformation to SOA begins with an analysis of the IT infrastructure to identify applications, business processes, and other software assets that become services, or otherwise support the SOA.

Metadata is data about data, or more specifically, information about the content of the data; service metadata is information about the services in a SOA. Service producers use service metadata to describe what service consumers need to know to interact with the service producers. Service metadata is stored in a metadata repository by service producers and then accessed by service consumers. A metadata repository provides visibility into the portfolio of assets, the traceability of the assets within that portfolio, the relationships and interdependencies that connect the assets to each other, the policies that govern use of the assets, and the projects that produce the assets and consume the assets.

### BRIEF DESCRIPTION OF THE DRAWINGS

FIG. 1 shows the system architecture for one embodiment.

FIG. 2 shows a method for one embodiment.

FIG. 3 shows a method for one embodiment.

FIG. 4 shows an example of a user selecting a business process to search for in an architecture diagram tool.

FIG. 5 shows an example of the user creating a business process, placing it in the architecture diagram, and specifying properties for the description of the asset in the metadata repository.

FIG. 6 shows an example of a user searching for a business process in the asset search panel and selecting a J2EE application server.

FIG. 7 shows an example of the user selecting one business process that was returned in the result set.

FIG. 8 shows an example of a user specifying a bidirectional metadata repository relationship between an approve expense business process and another business process.

FIG. 9 shows an example of a user associating a project profile with an architecture diagram.

FIG. 10 shows an example of the user exporting the project profile from the architecture diagram into the metadata repository.

FIG. 11 shows an example of a user submitting the project profile into the metadata repository.

FIG. 12 shows an example of a user creating a metadata repository asset from the architecture diagram that was exported.

FIG. 13 shows an example of a user accessing an asset in a metadata repository, wherein the asset was created from an architecture diagram.

FIG. 14 shows an example of a user accessing a relationship in a metadata repository, wherein the relationship was harvested from an architecture diagram.

### DETAILED DESCRIPTION

Service-Oriented Architecture (SOA) is a new approach to information technology that connects people, process, and technology in a dynamic, distributed environment. Although SOA provides the agility required to innovate and compete in today's economy, it also increases system complexity. To mitigate this risk, organizations control and track information technology investments to ensure alignment with corporate objectives. A service metadata repository enables SOA governance that provides comprehensive insight into the business impact of SOA. A service metadata repository can enable SOA governance to span the SOA lifecycle and unite resources from across divisions and geographies in a collaborative holistic approach to corporate decision-making and compliance by providing the automated exchange of metadata and service information among service consumers, providers, policy decision points, and other governance tools.

A service metadata repository provides role-based visibility into all SOA assets, regardless of source, through a centralized repository for business processes, services, applications, components, models, frameworks, policies, and data services. Visibility into assets under development minimizes redundancy and promotes service collaboration and reuse. A service metadata repository could also graphically display and navigate asset-to-asset and asset-to-project relationships and interdependencies to simplify impact analysis and ensure business alignment by enabling users to organize and link SOA assets to associated business processes.

Many existing software systems were designed and architected before Metadata Repositories existed to track enterprise architecture. What is needed is a way to harvest architecture diagrams and import architecture knowledge into a metadata repository, thereby enabling organizations to map entities in a metadata repository to existing architecture diagrams and comply with existing architecture modeling standards.

Many architecture tools include a pre-existing architectural framework which can be utilized to synchronize service metadata information between the architecture diagram and the service metadata repository. A far more difficult case is presented with pure drawing and graphical tools such as Microsoft Visio® that do not include a pre-existing architectural framework. Microsoft Visio® presents a far more difficult case because a drawing could represent anything, and it is necessary to interpret the drawing to determine what the diagrams mean in order to organize service metadata and synchronize the service metadata between the architecture diagram and the metadata repository.

Often an architecture diagram may include a box representing an entire collection of assets that are stored within a service metadata repository.

In one embodiment, an architecture diagram is created in a graphic user interface design tool. Architecture diagrams are then harvested from the design tool into the metadata repository. Users can search for assets in the metadata repository from within the design tool. The users can add assets from the metadata repository to the design tool. The users can link assets from the metadata repository to objects in the design tool. The users can add objects on an architecture diagram to the metadata repository and create a relationship between the object on the architecture diagram and the metadata in the metadata repository. Metadata stored in the metadata repository is synchronized with the entities and connectors displayed on the architecture diagram. The architecture diagram is then exported to the metadata repository.

In one embodiment, the design tool is Microsoft Visio®. Alternative embodiments use other design and modeling tools such as Telelogic System Architect®, Aris™, Popkin, Troux, and IBM Rational Software Architect®.

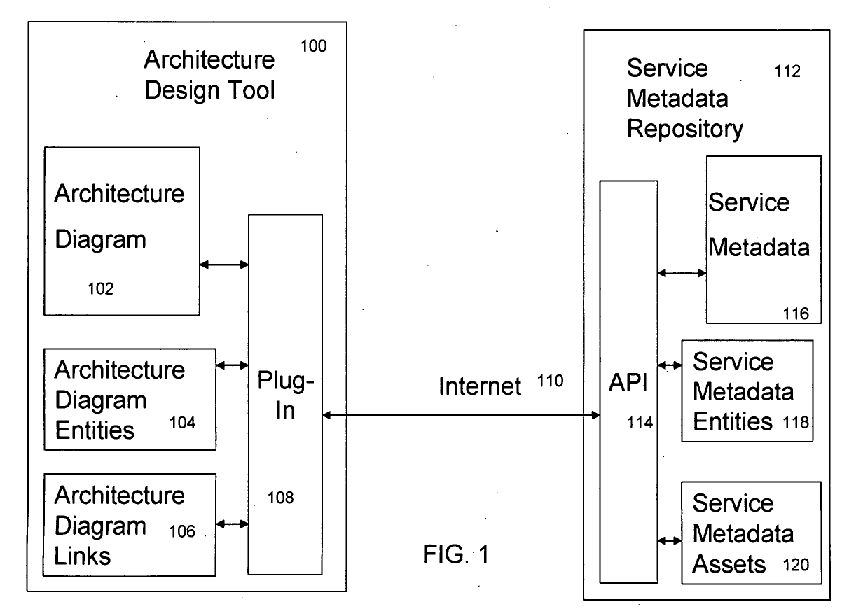

In accordance with an embodiment, the system architecture for one embodiment is shown in FIG. 1. An architecture design tool 100 with a graphic user interface enables users to create one or more architecture diagrams 102. Service metadata information contained in the architecture diagram 102 is harvested through a plug-in 108 over the internet 110 or another network into service metadata 116 in the service metadata repository 112. The plug-in 108 communicates to the service metadata repository 112 using an Application Programming Interface (API) 114 provided by the service metadata repository 112. The API 114 converts service metadata information into a format appropriate for storing in the service metadata repository 112. Entities 104 in the one or more architecture diagrams 102 are synchronized with entities 118 in the service metadata repository 112. Links 106 are added in the one or more architecture diagrams 102 to assets 120 stored in the service metadata repository 112. Service metadata assets 116 contained in the service metadata repository 112 can be harvested out of the metadata repository and placed into one or more architecture diagrams 102 in the architecture design tool 100.

In one embodiment, a data transformation utility transforms an architecture diagram 102 into a format for storing in the service metadata repository 112. In one embodiment, the data transformation utility is part of the plug-in 108. In one embodiment, the data transformation utility is part of the API 114. In one embodiment, the data transformation utility is separate from the plug-in 108 and the API 114. In one embodiment, the API 114 is a service metadata repository extensibility framework API that provides programmatic access to service metadata repository functionality.

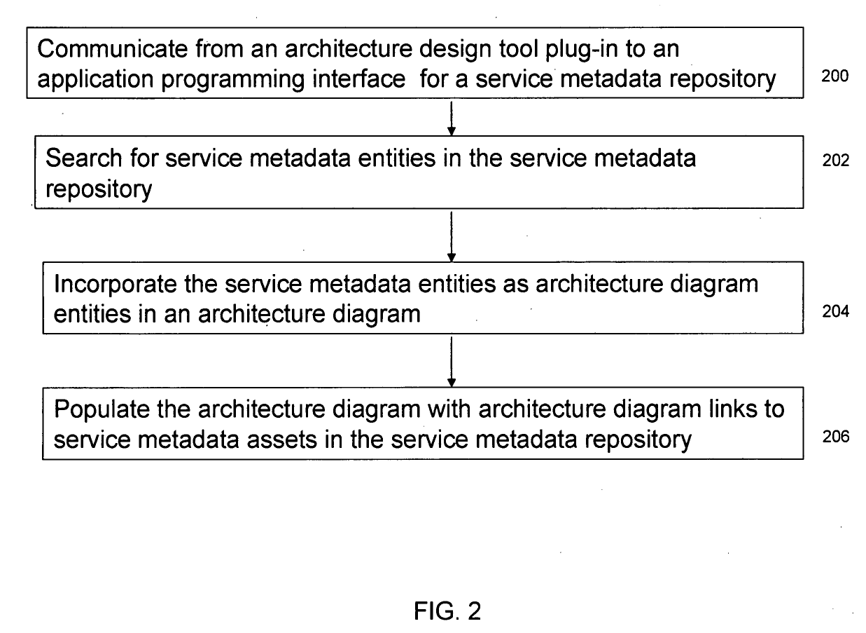

One embodiment is a method for harvesting service metadata from a metadata repository into an architecture diagram, shown in FIG. 2. In step 200, communicate from an architecture design tool plug-in to an application programming interface for a service metadata repository. In step 202, search for service metadata entities in the service metadata repository. In step 204, incorporate the service metadata entities as architecture diagram entities in an architecture diagram. In step 206, populate the architecture diagram with architecture diagram links to service metadata assets in the service metadata repository.

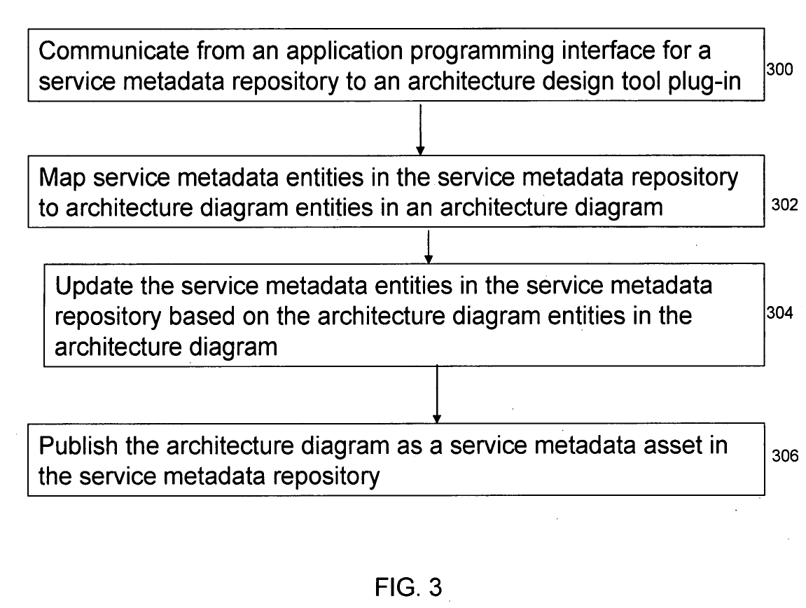

One embodiment is a method for harvesting service metadata from an architecture diagram into a metadata repository, shown in FIG. 3. In step 300, communicate from an application programming interface for a service metadata repository to an architecture design tool plug-in. In step 302, map service metadata entities in the service metadata repository to architecture diagram entities in an architecture diagram. In step 304, update the service metadata entities in the service metadata repository based on the architecture diagram entities in the architecture diagram. In step 306, publish the architecture diagram as a service metadata asset in the service metadata repository.

Although described as a series of steps, these methods do not require the steps to be executed in order or even as part of the same process.

### Mapping Entities in the Metadata Repository to Entities in Architecture Diagrams

Mapping entities in the metadata repository to architecture diagrams enables organizations to map entities in a metadata repository to their existing architecture modeling standards. In one embodiment, entities in the metadata repository are mapped to entities and properties in the architecture diagram. Metadata repository entities include asset types, categorizations, relationships, and collections of assets (for example—all of the versions of a particular asset).

In one embodiment, entities in the metadata repository are mapped to entities and properties in a design tool. In one embodiment, an enterprise architecture plug-in enables communication between the design tool and the metadata repository. In one embodiment, the design tool is Microsoft Visio®. Design tool entities include modeling objects and connectors. Design tool properties include color codes, layering, and additional metadata associated with design tool entities. Design tool users associate entities and properties in the design tool to entities in metadata repositories. In one embodiment, categories in the design tool are represented in two ways—through layered objects and through colors.

In one embodiment, users create associations from entities in the design tool to compliance templates, policies, and projects in the metadata repository.

In one embodiment, users selectively associate the objects in an architecture diagram with entities in the metadata repository and can choose whether the objects in the architecture diagram are included as metadata repository assets. For instance, the users might decide not to include the network or databases in the metadata repository. Some entities and properties in architecture diagrams that are not relevant to service metadata will not map to entities in the metadata repository.

In one embodiment, users selectively associate the relationships in an architecture diagram with the relationships in the metadata repository and can choose whether the relationships in the architecture diagram are included as metadata repository relationships. For instance, the users might decide not to include relationships between categories in the metadata repository. Some relationships in architecture diagrams that are not relevant to service metadata or related assets will not map to relationships in the metadata repository.

In one embodiment, users identify the metadata fields in the metadata repository asset type that is visible in the design tool. In one embodiment, there are metadata limitations in the design tool.

Harvesting the entities and relationships assumes that the organizations have established standard modeling approaches (i.e.—that they have stencils or templates and defined properties, and use these consistently across the organization). For organizations that don't have modeling standards, harvesting the diagrams is a more manual process and less automated.

Searching for Metadata Repository Entities from within the Architecture Diagram Tool

Being able to search for and view metadata repository entities from within a design tool gives visibility into the as-is and to-be elements of the architecture. The users can see existing and planned assets, existing categorizations, and existing relationships as they exist in the metadata repository while creating architecture diagrams in the design tool.

In one embodiment, design tool users can search for existing metadata repository assets and view the asset details, relationships (including directional information), and categories that exist in the metadata repository. In one embodiment, the results of the search are displayed to the users within a graphic user interface design tool. In one embodiment, the results of the search bring up a page from within the metadata repository.

In one embodiment, design tool users enter in a search term for an asset, the users receive a list of search results, and double-clicking on a particular search result brings up the asset details.

In one embodiment where the design tool is Microsoft Visio®, the metadata repository uses the Visual Studio .net framework and a Visual Studio .net plug-in to communicate between Microsoft Visio® and the metadata repository.

In one embodiment, design tool users can search for compliance templates and policies. In one embodiment, design tool users can search for and identify collections of assets.

### Incorporating Metadata Repository Entities Into Architecture Diagrams

Incorporating metadata repository entities into architecture diagrams enables consistency across different views of the architecture.

In one embodiment, design tool users can reuse existing metadata repository assets (both individual assets and collections of assets), relationships that exist in the metadata repository, and categories that exist in the metadata repository.

In one embodiment, the metadata repository can track the reuse in the architecture diagrams as a metric to enable conducting impact analysis and management change based on the reuse.

In one embodiment, the design tool file is associated with a metadata repository project in order to capture usage statistics and perform automated notifications.

### Creating Entities in the Metadata Repository Based on Entities in the Architecture Diagram

Creating entities in the metadata repository based on entities in the architecture diagram provides architects with an efficient approach to publish architectures to specific groups within an organization. It also enables “evergreening,” in that the published architectures can remain consistent with the latest changes in the metadata repository.

In one embodiment, the user can selectively publish individual entities, categorizations, assets, and relationships. In one embodiment, the user can publish everything in a single sheet of a design tool file. In one embodiment, the user can publish everything in a design tool file. Design tool users select the roles with the metadata repository that are permitted to view the architectural entities. A date stamp is included in the asset metadata, indicating which design tool generated the asset and when the asset was generated.

In one embodiment, a user chooses a design tool file to import, an asset is created for each design tool object (non-connector) in the diagram, and any objects connected by a connector in the architecture diagram are related in the metadata repository using the “Related to” relationship.

In one embodiment, architecture diagram objects are mapped to a metadata repository type. In one embodiment, all architecture diagram objects are treated as components and all connectors are mapped to a “Related to” relationship. In one embodiment, architecture diagram objects receive a range of designations within the metadata repository and connections are treated as a range of relationships within the metadata repository.

### Updating Entities in the Metadata Repository Based on Entities in the Architecture Diagram

Updating entities in the metadata repository based on entities in the architecture diagram provides architects with an efficient approach to publishing updated architectures to specific groups within an organization. This feature supports “evergreening” in that the architecture diagrams stay in synchronization with the metadata repository.

When an entity in the architecture diagram changes (i.e. the entity is moved, a property changes, metadata changes, or an entity is deleted), then the metadata repository is updated. The update to the metadata repository includes a data stamp in the asset metadata and an indication that the change occurred as a result of a change in the architecture diagram file.

Some organizations do not have a formal change management process for architecture diagrams. Furthermore, some organizations do not store their architecture diagrams in a version control system. The metadata repository's approach to change management allows for maximum flexibility.

In one embodiment, a list of metadata repository assets that will be modified by the change to the architecture diagram is presented to the user. The user is then prompted to select a course of action for each individual asset, or for a group of assets, or for all of the assets.

In one embodiment, each change to an architecture diagram is treated as a new asset version. In one embodiment, if a categorization is deleted, the categorization is retained in the metadata repository taxonomy. In an alternative embodiment, all of the assets in that categorization are presented to the user, and the user is prompted to select a course of action.

Populating Architecture Diagrams with Links to Metadata Repository Assets

Populating architecture diagrams with links to metadata repository Assets and Collections of assets eliminates the need for a manual synchronization process between architecture diagrams and metadata repository assets. Furthermore, it provides the users of architecture design tools with additional asset metadata, asset status, and progress information.

Once entities have been generated in the metadata repository as assets, categorizations, and collections of assets, as part of the creation/update process, links to the metadata repository entities will be written back to the architecture diagram file.

In one embodiment, URL links are added to each object in an architecture diagram that relates to a metadata repository asset. Other links include links to categorizations and “saved search” links to other asset collections. In one embodiment, relationships are linked to connectors.

### Publishing an Architecture Diagram as a Metadata Repository Asset

Publishing an architecture diagram in a format such that the architecture diagram is part of an asset detail or included as a metadata repository asset allows a means of visual navigation through the architecture to assets and collections of assets within the metadata repository.

In one embodiment, an architecture diagram file is associated with an asset in the metadata repository.

In one embodiment, the architecture diagram file is exported into Scalable Vector Graphics (SVG) format and the SVG file is saved on a path that corresponds to the associated asset detail. When a new SVG diagram is published, the corresponding asset is re-versioned.

In one embodiment, the entire architecture diagram file is synchronized with a metadata repository asset.

Harvesting Service Metadata from a Metadata Repository into an Architecture Diagram

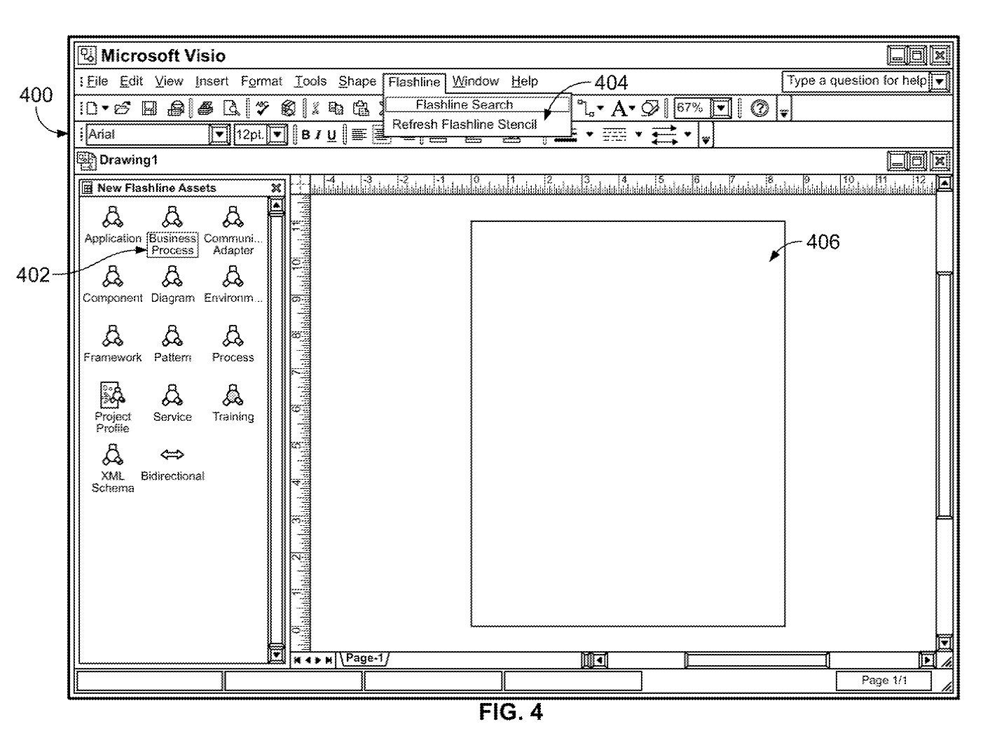

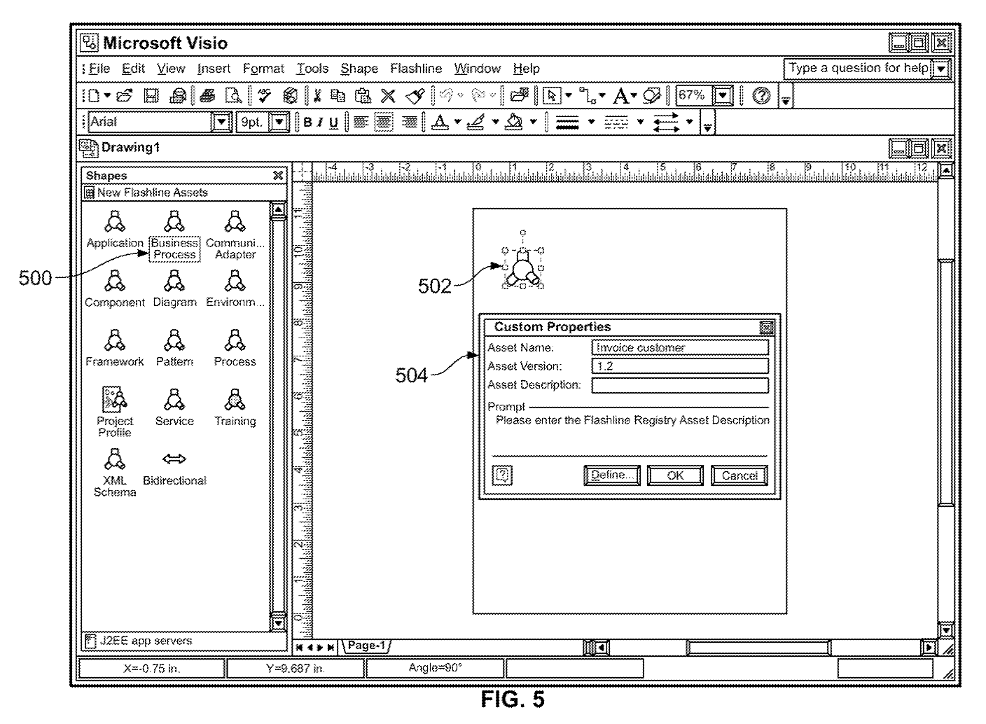

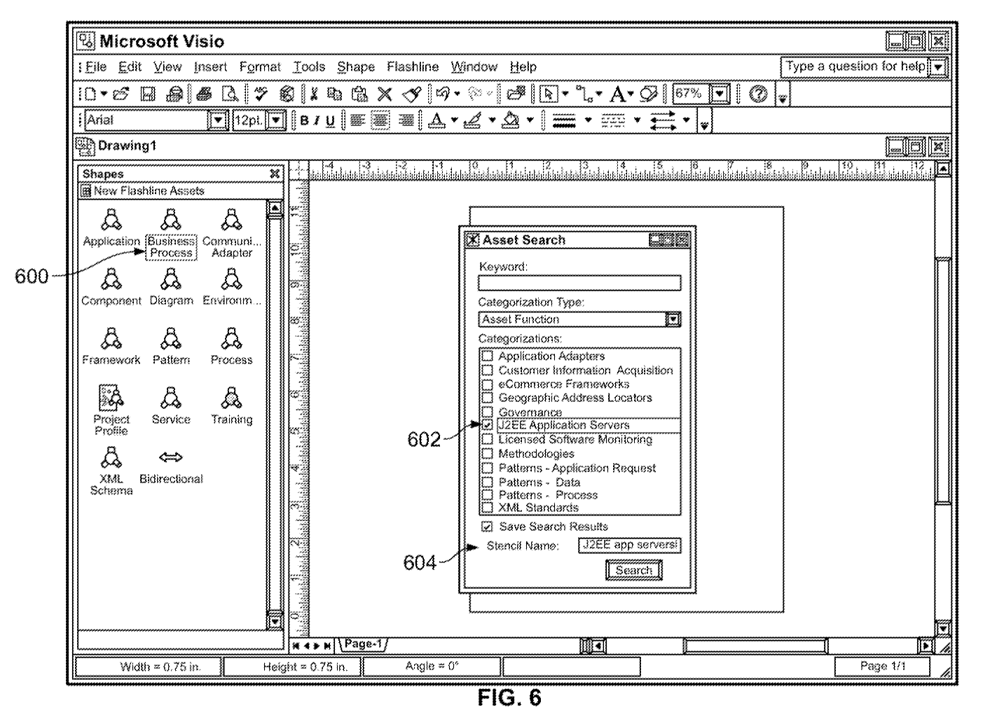

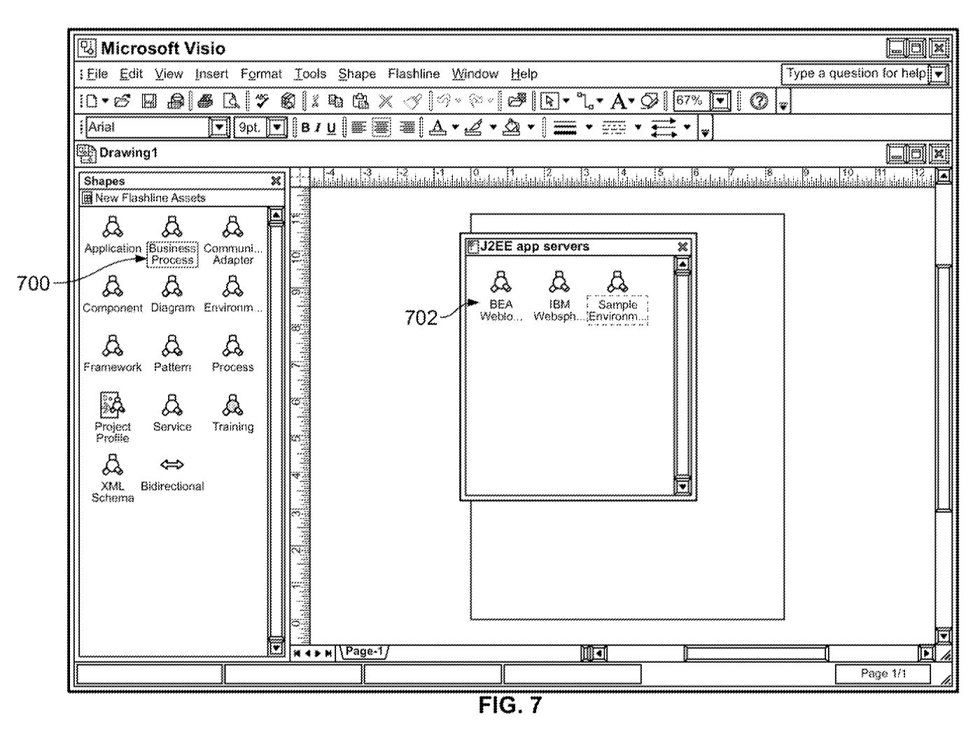

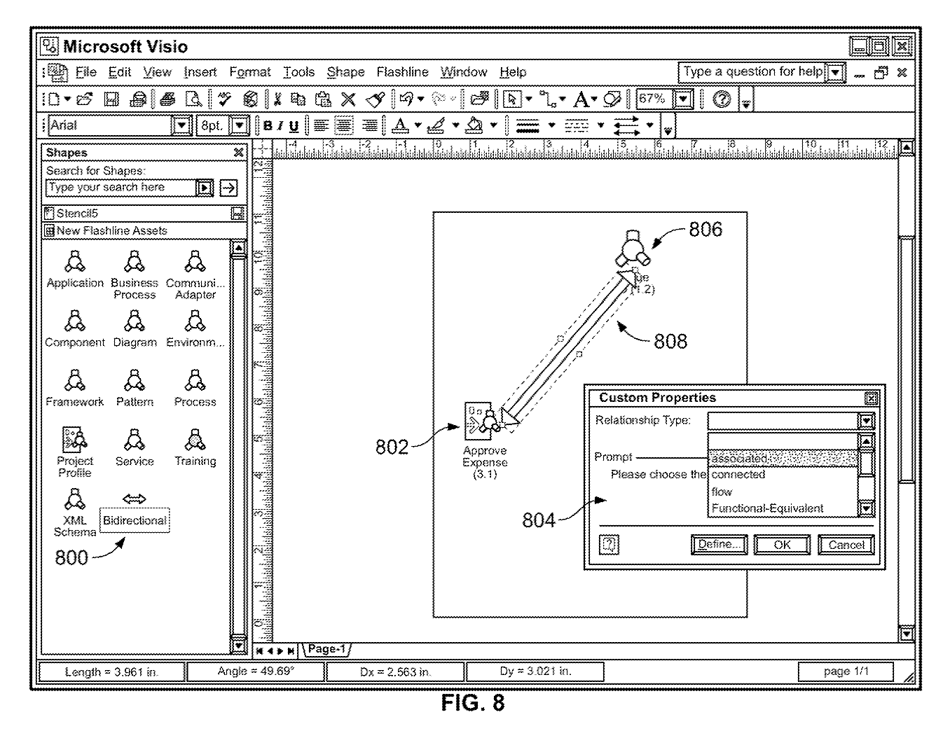

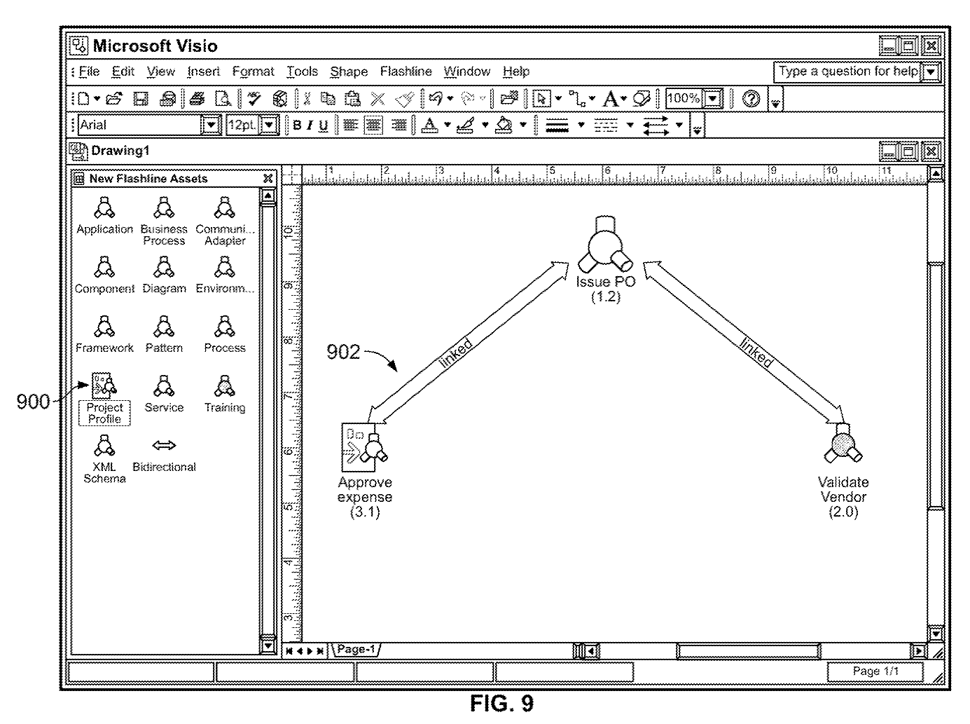

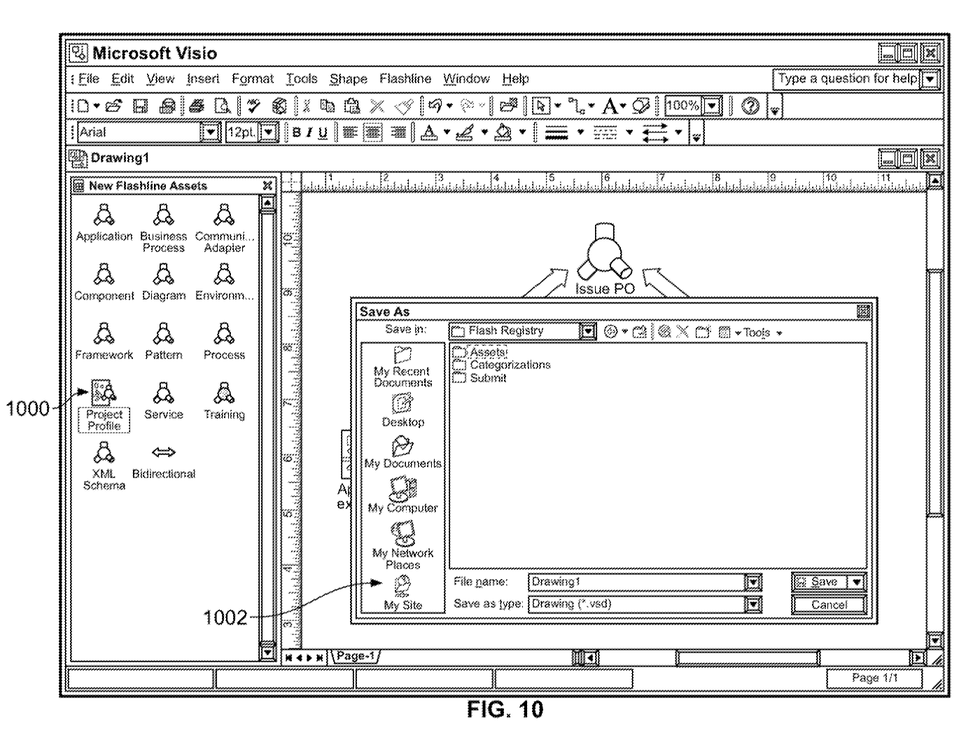

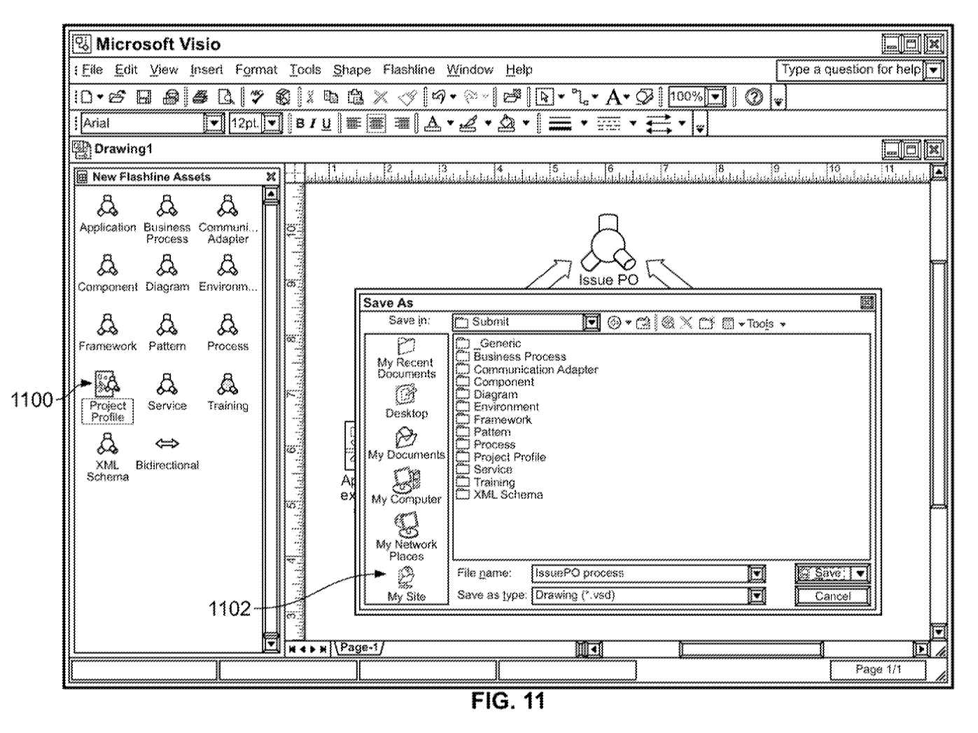

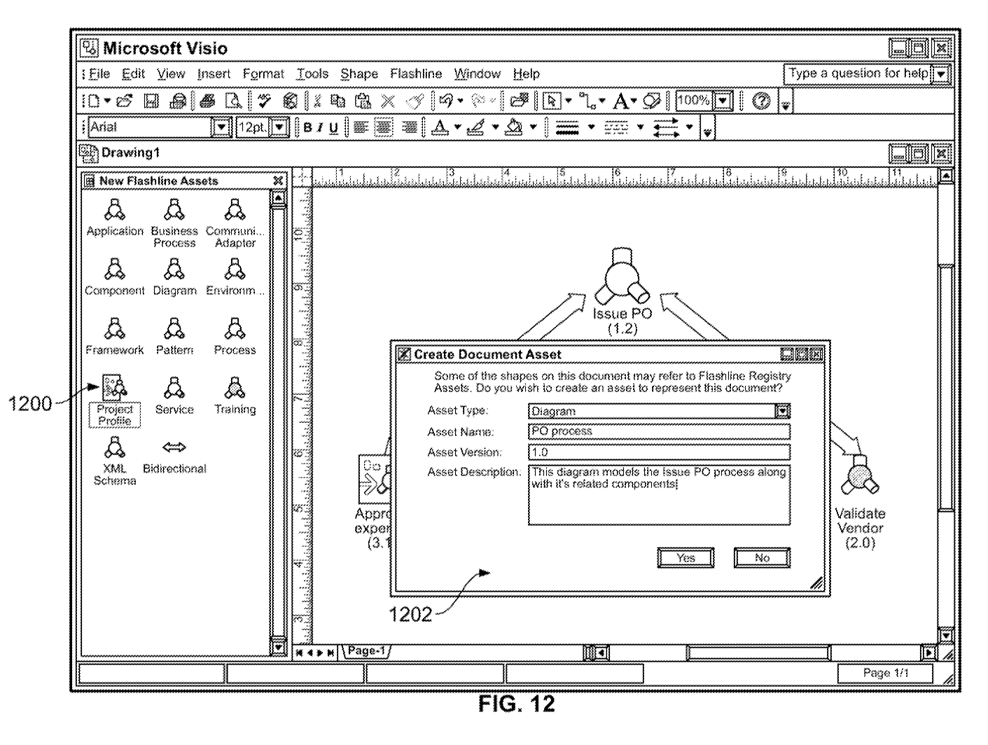

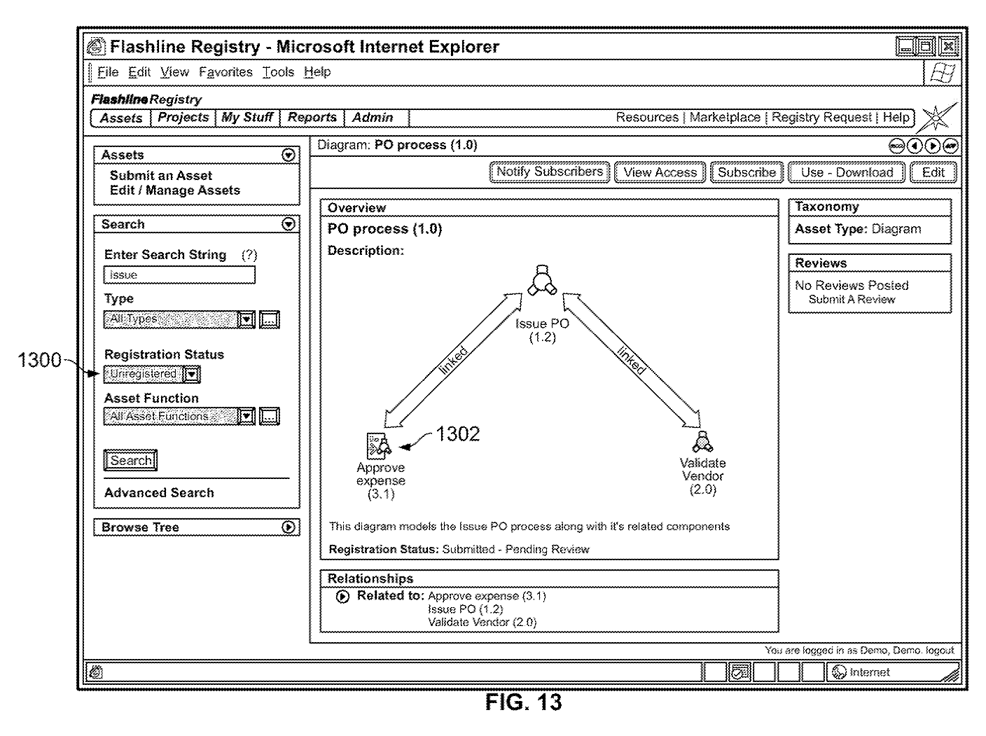

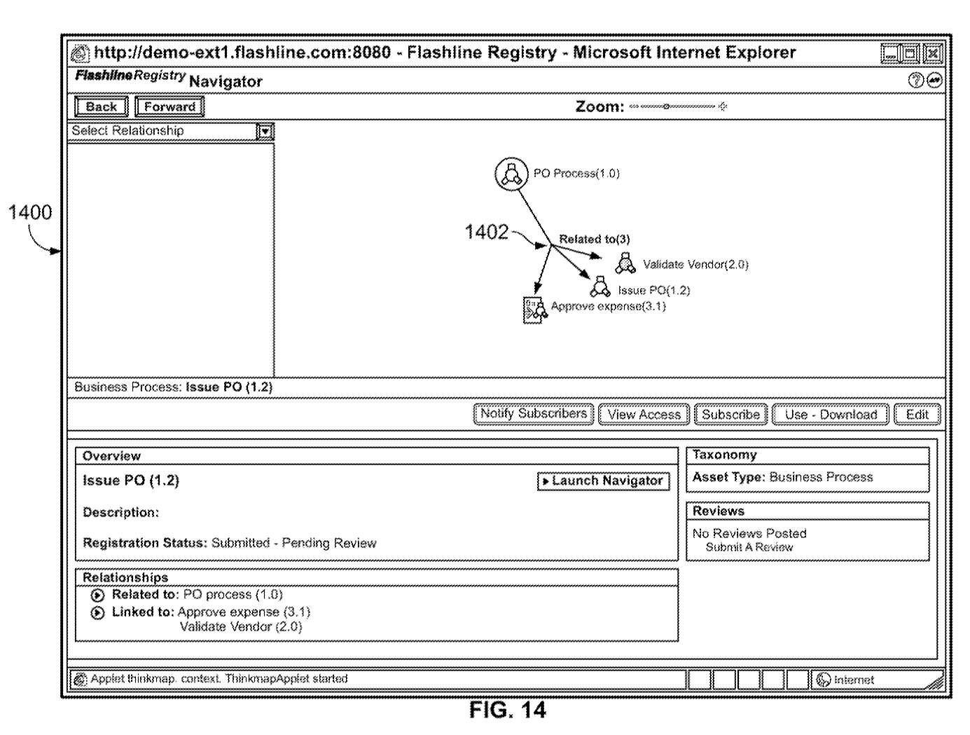

FIGS. 4 through 14 show an example harvesting service metadata information from an architecture diagram into a metadata repository and harvesting service metadata information from the metadata repository into the architecture diagram. In one embodiment, the example uses Microsoft Visio® as the architecture diagram tool. FIG. 4 shows an example of a user searching 404 for a selected business process 402 in a design tool 400 to build a new diagram 406. FIG. 5 shows an example of the user creating an invoice customer business process 500, placing it in the architecture diagram 502, and specifying properties 504 for the description of the asset in the metadata repository. FIG. 6 shows an example of a user searching for a business process 600 in the asset search panel 602 and selecting a stencil for J2EE application server 604. FIG. 7 shows an example of the user selecting one business process 700 and identifying the specific J2EE application server for the business process 702. The business process 700 is selected from stencils for service metadata repository assets. FIG. 8 shows an example of a user selecting a relationship type and specifying a bidirectional metadata repository relationship 800 between an approve expense business process 802 and the J2EE application server 806. In one embodiment, the relationship types depend on the relationship types available in the service metadata repository for this type of asset. In one embodiment, the plug-in leverages an API provided by the metadata repository. The custom properties window 804 allows the user to select the relationship in the metadata repository that represents the connector 808 in the architecture diagram. FIG. 9 shows an example of a user associating a project profile 900 with an architecture diagram 902. FIG. 10 shows an example of the user exporting the Issue PO business process diagram as a project profile 1000 from the architecture diagram into the metadata repository 1002. FIG. 11 shows an example of a user submitting the Issue PO business process using the project profile 1100 into the metadata repository 1102. FIG. 12 shows an example of a user creating a metadata repository asset 1202 from the architecture diagram that was exported 1200, and this asset will be stored in the metadata repository as a diagram. In one embodiment, the popup window 1202 is provided by the metadata repository and information is entered into the metadata repository describing the service metadata asset. In one embodiment, a similar dialog box pops up when the user creates a new asset in the architecture diagram based on service metadata from the metadata repository. FIG. 13 shows an example of a user accessing 1300 an asset 1302 in a metadata repository, wherein the asset is the architecture diagram created in the design tool and the current status is pending review. FIG. 14 shows an example of a user accessing a relationship 1402 in a metadata repository 1400, wherein the relationship was harvested from an architecture diagram and the asset is stored in the metadata repository as a business process asset.

One embodiment may be implemented using a conventional general purpose computer or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory of media or device suitable for storing instructions and/or data stored on any one of the computer readable medium (media). The present invention can include software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Embodiments of the present invention can include providing code for implementing processes of the present invention. The providing can include providing code to a user in any manner. For example, the providing can include providing the code on a physical media to a user; or any other method of making the code available.

Embodiments of the present invention can include a computer-implemented method for transmitting code which can be executed at a computer to perform any of the processes of embodiments of the present invention.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

1. A method for harvesting service metadata from a service metadata repository into an architecture diagram, comprising:
communicating from an architecture design tool plug-in to an application programming interface for a service metadata repository;
searching for service metadata entities in the service metadata repository;
incorporating the service metadata entities as architecture diagram entities in an architecture diagram; and
populating the architecture diagram with architecture diagram links to service metadata assets in the service metadata repository.

2. The method of claim 1, further comprising mapping architecture diagram entities in the service metadata repository to architecture diagram entities in the architecture diagram.

3. The method of claim 1, further comprising updating service metadata entities in the service metadata repository based on the architecture diagram entities in the architecture diagram.

4. The method of claim 1, further comprising publishing the architecture diagram as a metadata repository asset.

5. The method of claim 1, wherein architecture diagram entities in the architecture diagram comprise entities and properties.

6. The method of claim 1, wherein service metadata entities include asset types, categorizations, relationships, and collections of assets.

7. The method of claim 1, wherein a collection of assets includes multiple versions of an asset.

8. The method of claim 1, wherein a user selectively creates an association between the architecture diagram entities in the architecture diagram with the service metadata entities in the service metadata repository.

9. The method of claim 1, wherein searching enables users to view asset details, relationships, and categories that exist in the service metadata repository.

10. The method of claim 1, wherein service metadata assets in the service metadata repository are updated when a change is made to the architecture diagram.

11. The method of claim 1, further comprising updating service metadata assets in the service metadata repository by prompting a user to select a course of action for each changed service metadata asset, or for a group of service metadata assets, or for all service metadata assets.

12. The method of claim 1, wherein each change to an architecture diagram is treated as a new asset version.

13. A computer-readable storage medium, including instructions stored thereon which when read and executed by a computer cause the computer to perform steps comprising:
communicating from an architecture design tool plug-in to an application programming interface for a service metadata repository;
searching for service metadata entities in the service metadata repository;
incorporating the service metadata entities as architecture diagram entities in an architecture diagram; and
populating the architecture diagram with architecture diagram links to service metadata assets in the service metadata repository.

14. The computer-readable storage medium of claim 13, further comprising mapping architecture diagram entities in the service metadata repository to architecture diagram entities in the architecture diagram.

15. The computer-readable storage medium of claim 13, further comprising updating service metadata entities in the service metadata repository based on the architecture diagram entities in the architecture diagram.

16. The computer-readable storage medium of claim 13, further comprising publishing the architecture diagram as a metadata repository asset.

17. The computer-readable storage medium of claim 13, wherein architecture diagram entities in the architecture diagram comprise entities and properties.

18. The computer-readable storage medium of claim 13, wherein service metadata entities include asset types, categorizations, relationships, and collections of assets.

19. The computer-readable storage medium of claim 13, wherein service metadata assets in the service metadata repository are updated when a change is made to the architecture diagram.

20. A system comprising:
a service metadata repository;
a plug-in to an architecture design tool; and
an application programming interface that exposes functionality of the service metadata repository to the plug-in to the architecture design tool;
wherein the plug-in to the architecture design tool incorporates service metadata entities from the service metadata repository as architecture diagram entities in an architecture diagram.
